(19) United States
(12) Patent Application Publication
(10) Pub. No.: US 2002/0178059 A1
(43) Pub. Date: Nov. 28, 2002

(54) Information providing system and providing method thereof

(75) Inventor: Koichi Hatakeyama, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/153,628

(22) Filed: May 24, 2002

(30) Foreign Application Priority Data
May 28, 2001 (JP) 2001-158884

(51) Int. Cl. G06F 17/60

(52) U.S. Cl. 705/14

(57) ABSTRACT

The present invention is an information providing system for providing audio/multimedia content requested from a customer by using a recording medium, having: a first database for storing information regarding customer's interest on a customer basis; a second database for storing advertising information; a third database for storing audio/multimedia content; a first retrieval means for searching the first database based on an ID of a prescribed customer and obtaining information regarding interests of the customer; a second retrieval means for searching the second database based on the information regarding the customer's interests extracted from the first database and obtaining advertising information which fit for the customer's interests; and an information writing means for writing into the recording medium the advertising information extracted from the second database and audio/multimedia content requested from the customer and obtained from the third database.

### BACKGROUND OF THE INVENTION

1. Field of the Invention

The present invention relates to an information providing system and providing method thereof and, more particularly, to an advertisement information providing system capable of providing the latest advertisement information that suites the user's interests into an information-recording medium such as a video tape or a DVD at the time of selling or renting the information-recording medium.

2. Related Background Art

At present, in many stores and rental shops, video tapes, DVDs, and the like on which movies, music, and other various images and information are recorded are sold and rented. As described, for example, in Japanese Unexamined Utility Model Publication (KOKAI) No. 3-70474, commercials, that is, advertisement information data regarding a movie, music and the like are recorded at the head portion of each of the video tapes and the like. On the surface of the medium, advertisement information such as the title of a movie, music or the like, the cast, announcement of a campaign, and the like is printed.

Although the advertisement information is the latest one when the information-recording medium appears on the market, after the information-recording medium is sold or rented, the advertisement information gets older as the time elapses. Consequently, when the user rents a video tape of, for example, an old movie, advertisement information recorded or printed is unnecessary for the user at that time point.

The contents of the advertisement information are determined on the basis of schedule and plan of a movie-distributing agency and a sales company. Consequently, advertisement information that suits the user's interest is not always recorded or printed. In other words, a conventional advertisement information providing system is not an efficient system to the provider and the users.

### SUMMARY OF THE INVENTION

The present invention has been achieved to solve the above-mentioned problem and its object is to provide a system capable of producing an excellent effect on advertisement by preliminarily storing user's interests in a database and writing on the information-recording medium the latest advertisement information that suits the user's interests at the time of selling or renting the information-recording medium to the user.

In order to achieve the above-noted object, the present invention has the following described basic technical constitution.

The first aspect of the present invention is an information providing system for providing audio/multimedia content requested from a customer by using a recording medium, comprising: a first database for storing information regarding customer's interest on a customer basis; a second database for storing advertising information; a third database for storing audio/multimedia content; a first retrieval means for searching the first database based on an ID of a prescribed customer and obtaining information regarding interests of the customer; a second retrieval means for searching the second database based on the information regarding the customer's interests extracted from the first database and obtaining advertising information which fit for the customer's interests; and an information writing means for writing into the recording medium the advertising information extracted from the second database and audio/multimedia content requested from the customer and obtained from the third database.

The second aspect of the present invention is an formation providing system for providing audio/multimedia content requested from a customer by using a recording medium, comprising: a first database for storing information regarding customer's interest on a customer basis; a second database for storing advertising information; a recording medium on which audio/multimedia content is previously recorded; a first retrieval means for searching the first database based on an ID of a prescribed customer and obtaining information regarding interests of the customer; a second retrieval means for searching the second database based on the information regarding the customer's interests extracted from the first database and obtaining advertising information which fit for the customer's interests; and an information writing means for writing the advertising information extracted from the second database into the recording medium.

The third aspect of the present invention is an information providing system for providing audio/multimedia content requested from a customer to a customer's terminal via a communication network, comprising: a first database for storing information regarding customer's interest on a customer basis; a second database for storing advertising information; a third database for storing audio/multimedia content; a first retrieval means for searching the first database based on an ID of a prescribed customer and obtaining information regarding interests of the customer; a second retrieval means for searching the second database based on the information regarding the customer's interests extracted from the first database and obtaining advertising information which fit for the customer's interests; and a transmitting means for transmitting to the customer's terminal the advertising information extracted from the second database and audio/multimedia content requested from the customer and obtained from the third database.

The fourth aspect of the present invention is an information providing system for providing audio/multimedia content requested from a customer by using a recording medium, comprising: a first database for storing information regarding customer's interest on a customer basis; a second database for storing advertising information; a third database for storing audio/multimedia content; a first retrieval means for searching the first database based on an ID of a prescribed customer and obtaining information regarding interests of the customer; a second retrieval means for searching the second database based on the information regarding the customer's interests extracted from the first database and obtaining advertising information which fit for the customer's interests; an information writing means for writing into the recording medium the audio/multimedia content extracted from the third database; and a printing means for printing the advertising information extracted from the second database on a surface of the recording medium.

The fifth aspect of the present invention is an information providing system for providing audio/multimedia content requested from a customer by using a recording medium, comprising: a first database for storing information regarding customer's interest on a customer basis; a second database for storing advertising information; a recording medium on which audio/multimedia content is previously recorded; a first retrieval means for searching the first database based on an ID of a prescribed customer and obtaining information regarding interests of the customer; a second retrieval means for searching the second database based on the information regarding the customer's interests extracted from the first database and obtaining advertising information which fit for the customer's interests; and a printing means for printing the advertising information extracted from the second database on a surface of the recording medium.

The sixth aspect of the present invention is an information providing system for providing audio/multimedia content requested from a customer by using a recording medium, comprising: a first database for storing information regarding customer's interest on a customer basis; a second database for storing advertising information; a recording medium on which audio/multimedia content is previously recorded, the recording medium having a blank area in which an advertising information extracted from the second database is recorded; a measuring means for measuring a record capacity of the blank area of the recording medium; a first retrieval means for searching the first database based on an ID of a prescribed customer and obtaining information regarding interests of the customer; a second retrieval means for searching the second database based on the information regarding the customer's interests extracted from the first database and the record capacity of the blank area measured by the measuring means and obtaining advertising information which fit for the customer's interests; and an information writing means for writing the advertising information extracted from the second database within the blank area of the recording medium.

### BRIEF DESCRIPTION OF THE DRAWINGS

FIG. 1 is a diagram showing the configuration of a system according to a first embodiment.

FIG. 2 is a flowchart for explaining the flow of processes in the first embodiment.

FIG. 3 is a diagram showing the configuration of a system according to a second embodiment.

FIG. 4 is a flowchart for explaining the flow of processes in the second embodiment.

FIG. 5 is a diagram showing the configuration of a system according to a third embodiment.

FIG. 6 is a flowchart for explaining the flow of processes in the third embodiment.

FIG. 7 is a diagram showing the configuration of a system according to a fourth embodiment.

FIG. 8 is a flowchart for explaining the flow of processes in the fourth embodiment.

### DETAILED DESCRIPTION OF THE PREFERRED EMBODIMENTS

Embodiments of the present invention will be described hereinbelow with reference to the drawings.

### First Embodiment

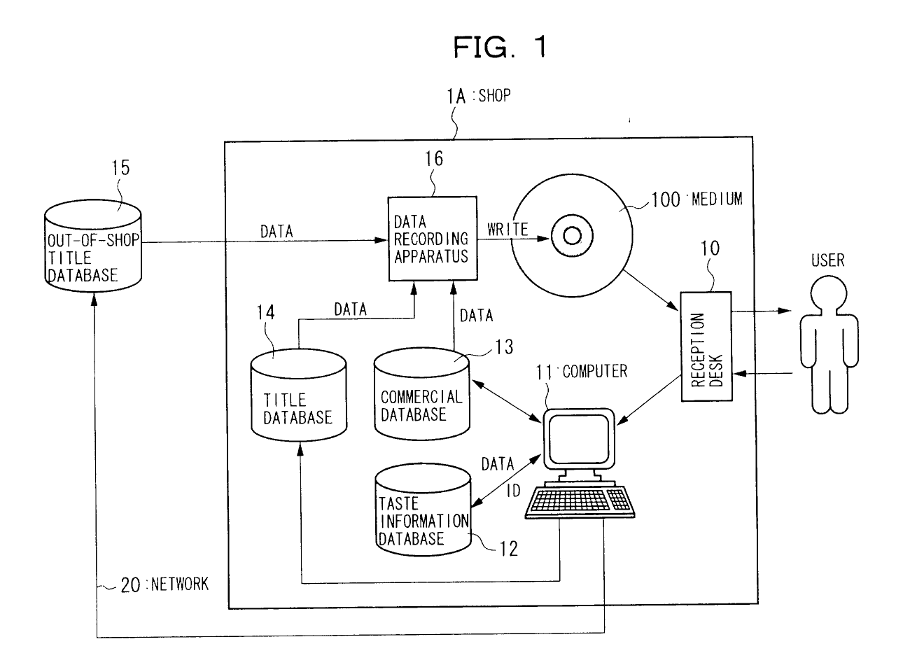

FIG. 1 is a block diagram showing the configuration of an advertisement information providing system according to a first embodiment of the present invention. In the embodiment, a case of writing the latest advertisement information that suits the user's interests into an information-recording medium at the time of actually renting the information-recording medium at a shop will be described. In following embodiments, the information-recording medium is a DVD, however, video tape, CD, CD-R, CD-RW, CD-ROM, DVD-R, DVD-RW, DVD-ROM, floppy disk, and IC card and, further, other information-recording media, magnetic recording media, and semiconductor recording media are applied to the system of the present invention as well. Also in the case of selling an information-recording medium, the following flow of processes can be applied.

A reference numeral 1A designates a shop of renting a medium 100 on which audio video data (hereinbelow, called AV data or audio/multimedia content) such as a movie or music is recorded to the user. The shop 1A has a reception desk 10 to which the user brings the title of a product that the user wishes to rent. Before renting a product, the user preliminarily registers information such as user's address, name, age, and sex, and the shop 1A manages the registered customer's information by adding a membership number (ID) peculiar to the user. This is similar to a membership system in a conventional rental shop.

The shop 1A further has a computer 11, a interest information database 12 which stores customer's interest data, a commercial database 13 which stores commercial data, a title database 14, an out-of-shop title database 15, and a data recording apparatus 16. The computer 11 serves as an information input terminal on the shop 1A and is an information processing apparatus such as a workstation server. The computer 11 controls the system of the first embodiment which will be described herein later. All the processes are performed under the control of a program stored in the computer 11.

The interest information database 12 is a database for storing information such as the user's sex, age, and renting history of the user on a user (ID) basis. These information data are updated each time the user rents a medium, accordingly information data are always stored in the latest state. In the commercial (advertisement information) database 13 as well, the latest commercials in various genres are stored as AV data. The commercials (advertisement information) are also always kept updated by movie distributing agencies, advertisement companies, and the like. In the title database 14, audio/multimedia content, that is, the main part of the movie, music, or the like is stored as AV data. On the other hand, the out-of-shop title database 15 is a database held by, for example, a movie distributing agency, a recording company, or the like and is connected to the computer 11 of the store 1A via a network 20. The data stored in the out-of-shop title database 15 is the AV data of the main part of a movie, music, or the like.

The data recording apparatus 16 can write AV data onto an information-recording medium 100 such as video tape, DVD, or the like and has the function of changing the setting of writable/write protect state of data to a medium. For example, a general apparatus presently used to manufacture products such as video tapes or DVDs can be used as the data recording apparatus 16. The information-recording media 100 are not limited to the above-described ones. Other magnetic recording media such as CD, CD-R, CD-RW, CD-ROM, DVD-R, DVD-RW, DVD-ROM, floppy disk, and semiconductor recording media such as IC card and the like can be also used.

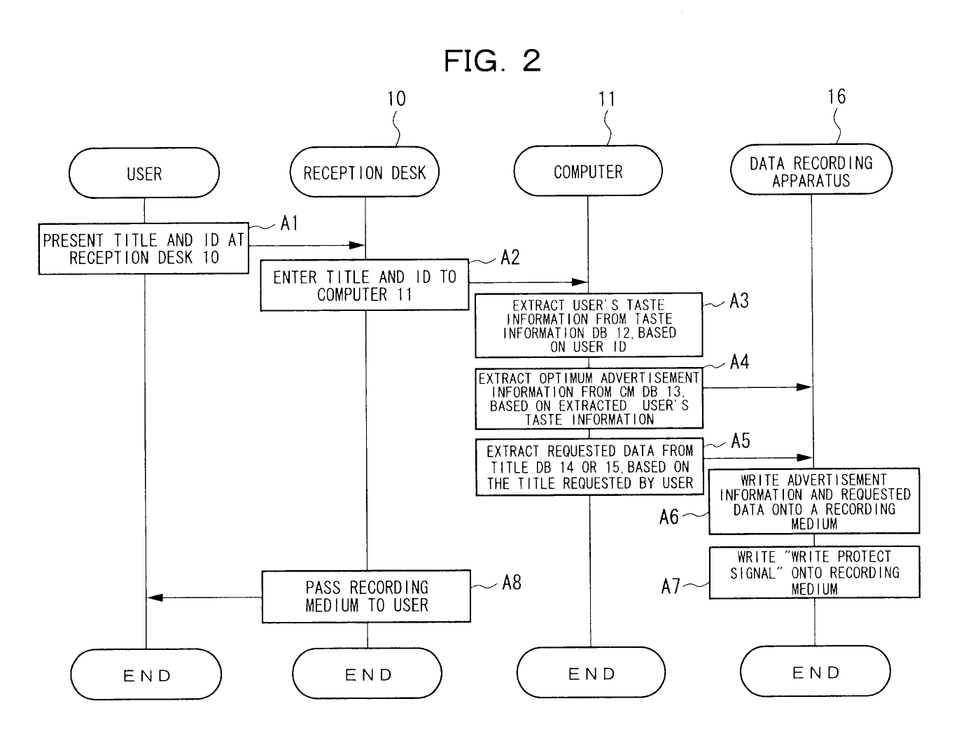

By referring to FIGS. 1 and 2, the flow of processes of the embodiment will be described. FIG. 2 is a flowchart for explaining the flow of processes according to the embodiment. First, the user presents the title of a product which the user wishes to rent and the membership number (ID) of the user to the reception desk 10 in the shop 1A (step A1). The shop 1A receives the user's request and enters the user ID and the title of the product to the computer 11 (step A2).

The computer 11 retrieves the interest information database 12 for the user ID and extracts the interests of the user from the interest information database 12 (step A3). Subsequently, based on the extraction results, the computer 11 extracts AV data of a commercial that best suits the user's interests from the commercial database 13 (step A4). From the entered title of the product, the computer 11 simultaneously searches the title database 14 or out-of-shop title database 15 for AV data of the corresponding main part (step A5). At this time, the AV data from the out-of-shop title database 15 is obtained by downloading.

Subsequently, the computer 11 controls the data recording apparatus 16 to write the AV data extracted from the corresponding databases into a DVD 100 (step A6). The order of writing is a commercial first and then a main part but may be opposite. On completion of writing, the data recording apparatus 16 writes a write protect signal onto the medium 100 so that the user cannot write data after that (step A7). By writing the write protect signal onto the medium 100, all the process are finished, and the DVD 100 is rented to the user from the reception desk 10 (step A8).

As described above, the first embodiment of the present invention is formed by a first database 12 for storing information regarding customer's interest on a customer basis; a second database 13 for storing advertising information; a third database 14 for storing audio/multimedia content; a first retrieval means (step A3) for searching the first database based on an ID of a prescribed customer and obtaining information regarding interests of the customer; a second retrieval means (step A4) for searching the second database based on the information regarding the customer's interests extracted from the first database and obtaining advertising information which fit for the customer's interests; and an information writing means (step A6,A7) for writing into the recording medium the advertising information extracted from the second database and audio/multimedia content requested from the customer and obtained from the third database.

### Second Embodiment

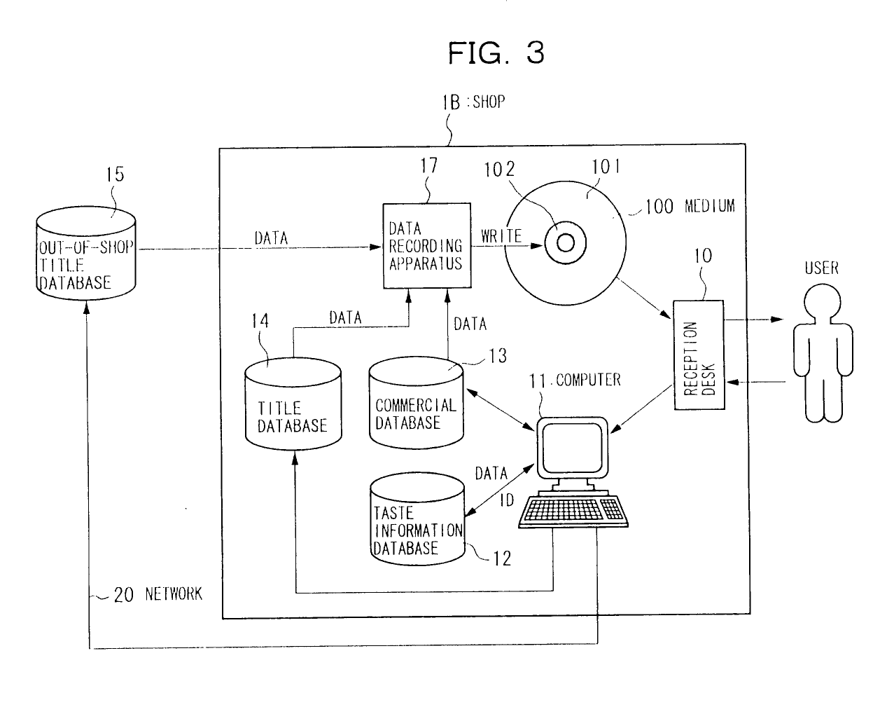

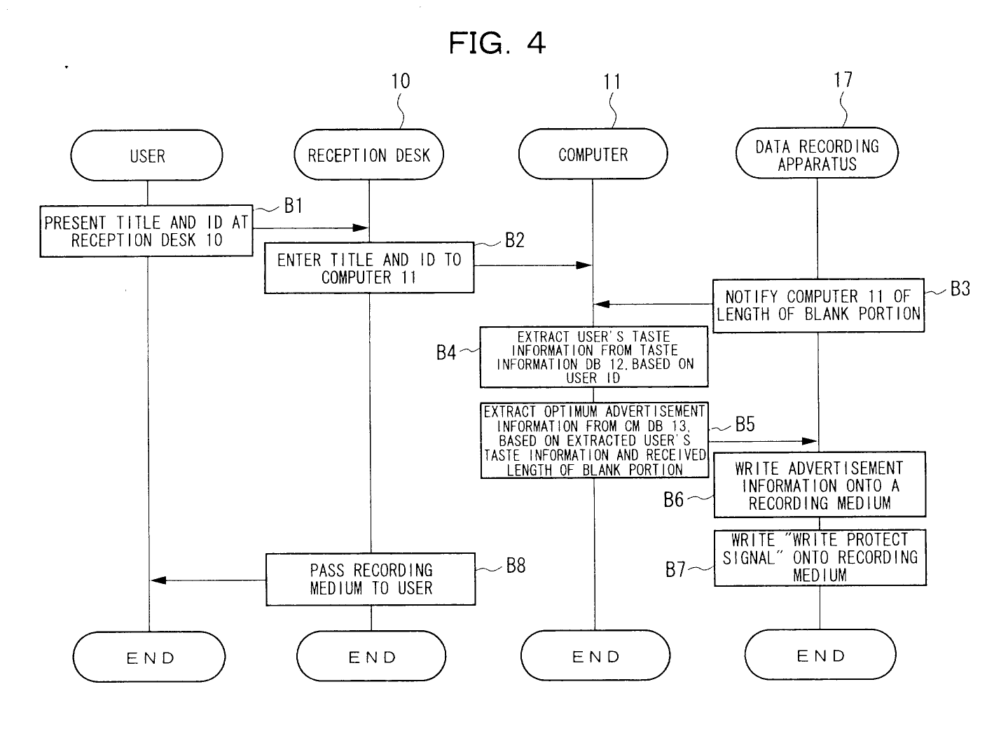

A second embodiment of the present invention will now be described with reference to FIGS. 3 and 4. FIG. 3 is a diagram showing the configuration according to the second embodiment of the present invention. In the second embodiment, in a manner similar to the first embodiment, the case of renting a DVD in the shop 1B will be described. The difference between the first embodiment and the second embodiment is that AV data as a main part is preliminarily recorded in a DVD to be rented in the second embodiment and AV data for only a commercial is written at the time of renting the DVD 100 to the user. Therefore, no AV data is recorded in the head portion of a DVD 100, that is, in the second embodiment, the head portion of the DVD 100 is set in a blank state up to the main part data.

In Fig.3, the reference numeral 101 designates an area for recording audio/multimedia content on the DVD 100, and the reference numeral 102 designates an area for recording advertising information.

The shop 1B has reception desk 10, computer 11, interest information database 12, commercial database 13, and title database 14. The computer 11 controls the system of the second embodiment, and all of the processes are performed under the control of a program stored in the computer 11. Components functioning similar to those in the first embodiment are designated by the same reference numerals and their description will not be repeated here.

A data recording apparatus 17 has means for measuring the length of a blank portion into which AV data of a commercial is to be written, and can transmit/receive information regarding the length to/from the computer 11. Although the length of the commercial portion written in an information-recording medium such as a DVD is not generally fixed, when a DVD including the commercial portion having a predetermined length can be used, it is unnecessary to measure the length of the blank portion.

The flow of processes of the second embodiment will now be described by referring to FIGS. 3 and 4. FIG. 4 is a flowchart for explaining the flow of processes in the second embodiment. First, the user presents the title of a product that the user wishes to rent and the membership number (ID) of the user to the reception desk 10 (step B1). The shop 1B receives the user's request and enters the user ID and the title of the product to the computer 11 (step B2). The DVD of the corresponding title is set in the data recording apparatus 17. At this time point, the data recording apparatus 17 measures the length of the blank portion of the set DVD and notifies the computer 11 of the length information (step B3).

The computer 11 retrieves the interest information database 12 for the user ID and extracts the interests of the user from the interest information database 12 (step B4). Based on the extracted interest information and the length information notified from the data recording apparatus 17, the computer 11 selects a commercial that best suits the user and extracts the AV data from the commercial database 13 (step B5). Subsequently, the computer 11 controls the data recording apparatus 17 to write the AV data of the commercial into a DVD 100 (step B6). The order of writing is the commercial first and then the main part but may be opposite. On completion of the writing, the data recording apparatus 17 writes a write protect signal into a medium 100 so that data cannot be written after that (step B7). By the writing the write protect signal, all the process are finished, and the DVD 100 is rented to the user from the reception desk 10 (step B8).

### Third Embodiment

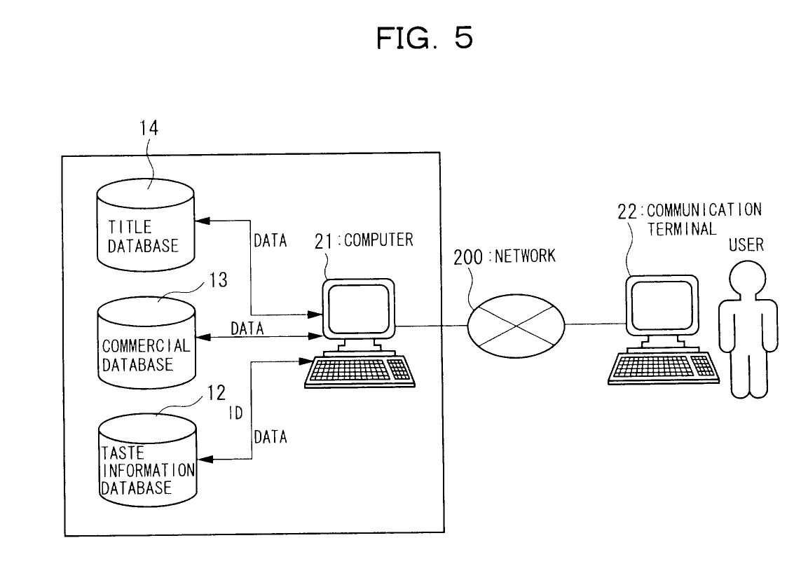

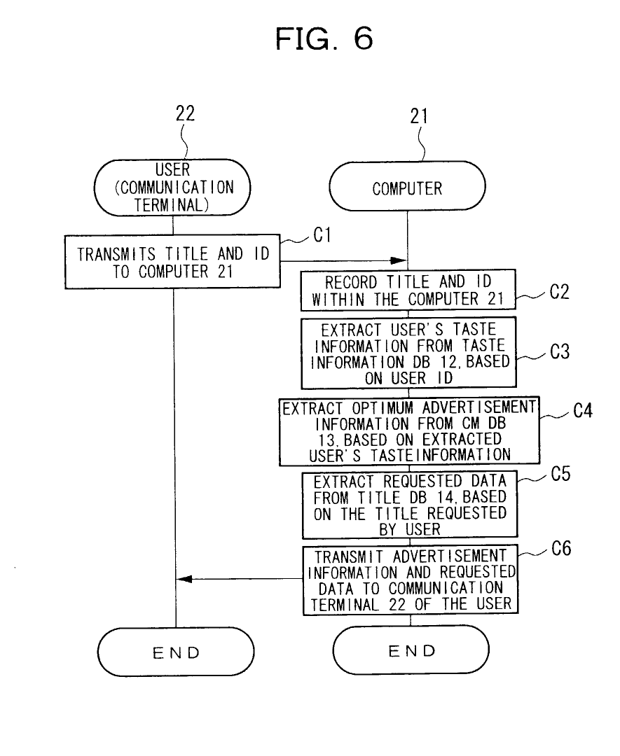

A third embodiment of the present invention will now be described with reference to FIGS. 5 and 6. FIG. 5 is a diagram showing the configuration according to the third embodiment of the present invention. In the third embodiment, different from the first and second embodiments of renting a medium by using an actual shop, the case of distributing (selling) AV data via a network to the user will be described. The network is the Internet or the like but a line dedicated to members may be provided. The user preliminarily registers information such as user's address, name, age, sex, and the like before purchasing a product, and the information is managed by assigning a membership number (ID) peculiar to a user in a manner similar to the first embodiment.

As shown in FIG. 5, in the third embodiment, a system includes a computer 21, the interest information database 12, commercial database 13, and title database 14. The computer 21 such as a workstation server serves as an information-processing terminal and is connected to a communication terminal 22 of the user via a network 200. The computer 21 controls the system of the third embodiment, and all of the processes are performed under the control of a program stored in the computer 21. Components functioning similar to those in the first embodiment are designated by the same reference numerals and their description will not be repeated here.

The flow of processes of the third embodiment will now be described by referring to FIGS. 5 and 6. FIG. 6 is a flowchart for explaining the flow of processes in the third embodiment. First, the user transmits the title of a product that the user desires to rent and membership number (ID) to the computer 21 by using the communication terminal 22 of the user (step C1). The computer 21 receives the request from the user and records the user ID and the title of the product (step C2).

Subsequently, the computer 21 searches the interest information database 12 for the user ID and extracts the interest information of the user (step C3). Based on the extracted interest information, the computer 21 selects a commercial that best suits the user and extracts the AV data of the commercial from the commercial database 13 (step C4). The computer 21 extracts AV data regarding the main part of the product's title requested by the user from the title database 22 (step C5). After that, the extracted AV data of the commercial and the main part is transmitted to the communication terminal 22 of the user via a network (step C6).

Preferably, the AV data to be transmitted to the communication terminal 22 of the user is set in a write protect state so that the user cannot write information to the received data. It is sufficient to receive the payment of sales from the user by debiting a pre-registered credit card or a pre-registered bank account, or by sending a bill, or the like.

### Fourth Embodiment

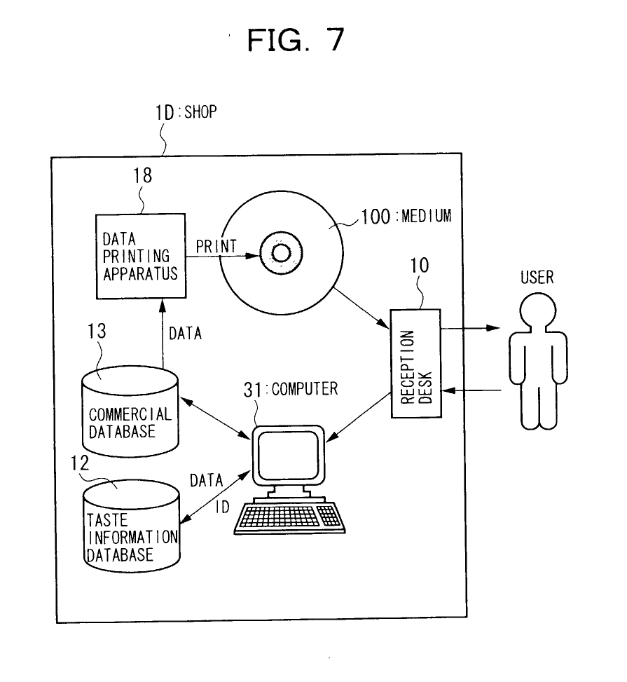

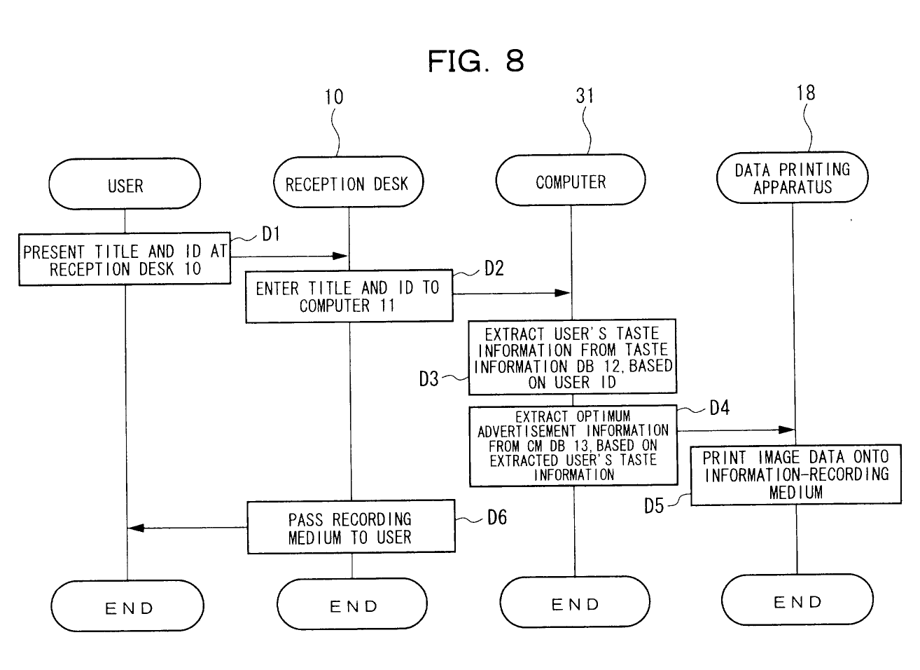

A fourth embodiment of the present invention will now be described with reference to FIGS. 7 and 8. FIG. 7 is a diagram showing a configuration according to the embodiment. The shop 1D has the reception desk 10, a computer 31, the interest information database 12, the commercial database 13, and a data printing apparatus 18. The computer 31 controls the system of the fourth embodiment of the present invention. All the processes are performed under the control of a program stored in the computer 31. The components functioning similar to the components in the first embodiment are designated by the same reference numerals and their description will not be repeated here.

In the commercial database 13, the latest advertisements in various genres are stored as image data. According to the shape of the surface of an information-recording medium, some kinds of image data are held. On the other hand, the data printing apparatus 18 is a printing apparatus capable of printing the image by using a paint, making and adhering a seal of the image, or exposing the surface with light, on the surface of the information-recording medium such as a DVD or a video tape. When using the above-mentioned technique, conventional printing and exposing techniques can be applied.

The flow of processes of the fourth embodiment will now be described by referring to FIGS. 7 and 8. FIG. 8 is a flowchart for explaining the flow of processes in the fourth embodiment. In this embodiment, in a manner similar to the first embodiment, the case of renting a DVD at the shop ID will be described hereinafter. It is assumed that AV data of a commercial and the main part is already recorded on the DVD 100. First, the user presents the title of a product desired to be rented and the user's membership number (ID) to the reception desk 10 in the shop 1D (step D1). The shop ID receives the request from the user and enters the user ID and the title of the product to the computer 31 (step D2).

The DVD 100 of the title is set in the data printing apparatus 18. The computer 31 retrieves the interest information database 12 for the user ID and extracts the interest information of the user (step D3). Subsequently, on the basis of the extraction results, the computer 31 extracts image data of an advertisement that best suits the interests of the user from the commercial database 13 (step D4). Subsequently, the computer 31 controls the data printing apparatus 18 to print the image data onto the surface of the DVD by using a proper paint (step D5). After completion of the printing, the DVD is rented to the user from the reception desk 10 (step D6).

The case of renting a medium on which an advertisement is printed by using a proper paint has been described. After the medium is returned from the user, it is sufficient to overwrite the advertisement by using a paint of, for example, black or white and print a new advertisement on it. In the case of adhering what is called a label such as a seal, it is sufficient to peel the seal off and adhere a new seal. The fourth embodiment may be combined with the first or second embodiment.

As described above, first, advertisement of the present invention is recorded or printed based on the user's interests, accordingly the advertisement information is the latest one at the time, so that an advertisement provider can expect increase in the effect of the advertisement. Second, by analyzing a advertisement provided to the user and purchase/rental history of the user, it is possible to recognize the actual effect of the advertisement. Third, although a advertisement used in the prior art is one regarding only movies, an advertisement of a commodity or the like can be effectively provided to the user according to the present invention.

The advertisement information providing system of the present invention is not limited to the foregoing embodiments, but various modifications can be considered. Although it has been described in the embodiments that AV data of the main part to be rented to the user is AV data regarding a movie or video images of music, for example, the AV data my be data of only music, game software, or a program of computer software. In the case of a program, by writing a trial version of software instead of AV data of an advertisement, the software can be effectively advertised.

Although a commercial database 13 and a title database 14 are disposed in a shop in the foregoing embodiments, like the out-of-shop title database 15, it is possible to place all of the databases in a server of a advertisement provider or the like and download the data from the server of a advertisement provider or the like. In this case, the install space in the shop can be eliminated. On the shop side, a work of updating advertisement data becomes unnecessary, therefore it saves the time for updating advertisement data.

By linking the interest information database with an external database such as history data of accesses to a home page dedicated to members of a shop, the interests of the user can be more accurately grasped. Since the interest information database includes the identify information of the user, it is preferable to encrypt the data. By the encryption, even in the case where the data leaks, the identify information can be protected.

Although the title requested by the user is actually received at a reception desk in a shop in the first, second, and fourth embodiments, for example, a system of reserving a title received from a communication terminal of the user via a network can be also introduced. In this case, by preliminarily inputting a title desired and the date of pickup, the user can pick up a medium without waiting time.

What is claimed is:

1. An information providing system for providing audio/multimedia content requested from a customer by using a recording medium, comprising:
a first database for storing information regarding customer's interest on a customer basis;
a second database for storing advertising information;
a third database for storing audio/multimedia content;
a first retrieval means for searching said first database based on an ID of a prescribed customer and obtaining information regarding interests of said customer;
a second retrieval means for searching said second database based on said information regarding said customer's interests extracted from said first database and obtaining advertising information which fit for said customer's interests; and
an information writing means for writing into said recording medium said advertising information extracted from said second database and audio/multimedia content requested from said customer and obtained from said third database.

2. An information providing system for providing audio/multimedia content requested from a customer by using a recording medium, comprising:
a first database for storing information regarding customer's interest on a customer basis;
a second database for storing advertising information;
a recording medium on which audio/multimedia content is previously recorded;
a first retrieval means for searching said first database based on an ID of a prescribed customer and obtaining information regarding interests of said customer;
a second retrieval means for searching said second database based on said information regarding said customer's interests extracted from said first database and obtaining advertising information which fit for said customer's interests; and
an information writing means for writing said advertising information extracted from said second database into said recording medium.

3. An information providing system for providing audio/multimedia content requested from a customer to a customer's terminal via a communication network comprising:
a first database for storing information regarding customer's interest on a customer basis;
a second database for storing advertising information;
a third database for storing audio/multimedia content;
a first retrieval means for searching said first database based on an ID of a prescribed customer and obtaining information regarding interests of said customer;
a second retrieval means for searching said second database based on said information regarding said customer's interests extracted from said first database and obtaining advertising information which fit for said customer's interests; and
a transmitting means for transmitting to said customer's terminal said advertising information extracted from said second database and audio/multimedia content requested from said customer and obtained from said third database.

4. An information providing system for providing audio/multimedia content requested from a customer by using a recording medium, comprising:
a first database for storing information regarding customer's interest on a customer basis;
a second database for storing advertising information;
a third database for storing audio/multimedia content;
a first retrieval means for searching said first database based on an ID of a prescribed customer and obtaining information regarding interests of said customer;
a second retrieval means for searching said second database based on said information regarding said customer's interests extracted from said first database and obtaining advertising information which fit for said customer's interests;
an information writing means for writing into said recording medium said audio/multimedia content extracted from said third database; and
a printing means for printing said advertising information extracted from said second database on a surface of said recording medium.

5. An information providing system for providing audio/multimedia content requested from a customer by using a recording medium, comprising:
a first database for storing information regarding customer's interest on a customer basis;
a second database for storing advertising information;
a recording medium on which audio/multimedia content is previously recorded;
a first retrieval means for searching said first database based on an ID of a prescribed customer and obtaining information regarding interests of said customer;
a second retrieval means for searching said second database based on said information regarding said customer's interests extracted from said first database and obtaining advertising information which fit for said customer's interests; and
a printing means for printing said advertising information extracted from said second database on a surface of said recording medium.

6. An information providing system for providing audio/multimedia content requested from a customer by using a recording medium, comprising:
a first database for storing information regarding customer's interest on a customer basis;
a second database for storing advertising information;
a recording medium on which audio/multimedia content is previously recorded, said recording medium having a blank area in which an advertising information extracted from said second database is recorded;
a measuring means for measuring a record capacity of said blank area of said recording medium;
a first retrieval means for searching said first database based on an ID of a prescribed customer and obtaining information regarding interests of said customer;
a second retrieval means for searching said second database based on said information regarding said customer's interests extracted from said first database and said record capacity of said blank area measured by said measuring means and obtaining advertising information which fit for said customer's interests; and
an information writing means for writing said advertising information extracted from said second database within said blank area of said recording medium.

7. An information providing method of an information providing system which provides audio/multimedia content requested from a customer by using a recording medium, comprising:
a first database for storing information regarding customer's interest on a customer basis;
a second database for storing advertising information;
a third database for storing audio/multimedia content;
wherein said method comprising the steps of:
searching said first database based on an ID of a prescribed customer and obtaining information regarding interests of said customer;
searching said second database based on said information regarding said customer's interests extracted from said first database and obtaining advertising information which fit for said customer's interests; and
writing into said recording medium said advertising information extracted from said second database and audio/multimedia content requested from said customer and obtained from said third database.

8. An information providing method of an information providing system which provides audio/multimedia content requested from a customer by using a recording medium, comprising:
a first database for storing information regarding customer's interest on a customer basis;
a second database for storing advertising information;
a recording medium on which audio/multimedia content is previously recorded;
wherein said method comprising the steps of:
searching said first database based on an ID of a prescribed customer and obtaining information regarding interests of said customer;
searching said second database based on said information regarding said customer's interests extracted from said first database and obtaining advertising information which fit for said customer's interests; and
writing said advertising information extracted from said second database into said recording medium.

9. An information providing method of an information providing system which provides audio/multimedia content requested from a customer to a customer's terminal via a communication network, comprising:
a first database for storing information regarding customer's interest on a customer basis;
a second database for storing advertising information;
a third database for storing audio/multimedia content;
wherein said method comprising the steps of:
searching said first database based on an ID of a prescribed customer and obtaining information regarding interests of said customer;
searching said second database based on said information regarding said customer's interests extracted from said first database and obtaining advertising information which fit for said customer's interests; and
transmitting to said customer's terminal said advertising information extracted from said second database and audio/multimedia content requested from said customer and obtained from said third database.

10. A computer program of an information providing system which provides audio/multimedia content requested from a customer by using a recording medium, comprising:
a first database for storing information regarding customer's interest on a customer basis;
a second database for storing advertising information;
a third database for storing audio/multimedia content;
wherein said computer program causing a computer to execute a sequential processing comprising the steps of:
searching said first database based on an ID of a prescribed customer and obtaining information regarding interests of said customer;
searching said second database based on said information regarding said customer's interests extracted from said first database and obtaining advertising information which fit for said customer's interests; and
writing into said recording medium said advertising information extracted from said second database and audio/multimedia content requested from said customer and obtained from said third database.

11. A computer program of an information providing system which provides audio/multimedia content requested from a customer by using a recording medium, comprising:
a first database for storing information regarding customer's interest on a customer basis;
a second database for storing advertising information;
a recording medium on which audio/multimedia content is previously recorded;
wherein said computer program causing a computer to execute a sequential processing comprising the steps of:
searching said first database based on an ID of a prescribed customer and obtaining information regarding interests of said customer;
searching said second database based on said information regarding said customer's interests extracted from said first database and obtaining advertising information which fit for said customer's interests; and
writing said advertising information extracted from said second database into said recording medium.

12. A computer program of an information providing system which provides audio/multimedia content requested from a customer to a customer's terminal via a communication network comprising:
a first database for storing information regarding customer's interest on a customer basis;
a second database for storing advertising information;
a third database for storing audio/multimedia content;
wherein said computer program causing a computer to execute a sequential processing comprising the steps of:
searching said first database based on an ID of a prescribed customer and obtaining information regarding interests of said customer;
searching said second database based on said information regarding said customer's interests extracted from said first database and obtaining advertising information which fit for said customer's interests; and
transmitting to said customer's terminal said advertising information extracted from said second database and audio/multimedia content requested from said customer and obtained from said third database.
